(19) United States
(12) Patent Application Publication
(10) Pub. No.: US 2016/0303554 A1
(43) Pub. Date: Oct. 20, 2016

(54) CATALYST, HYDROGENATION OF HYDROGEN CARBONATE, HYDROGEN STORAGE SYSTEM

(71) Applicant: DEBRECENI EGYETEM, Debrecen (HU)

(72) Inventors: Henrietta GYORVÁRINÉHORVÁTH, Debrecen (HU); Gábor PAPP, Debrecen (HU); Ferenc JOÓ, Debrecen (HU); Ágnes KATHÓ, Debrecen (HU)

(21) Appl. No.: 15/038,645

(22) PCT Filed: Sep. 17, 2014
(86) PCT No.: PCT/HU2014/000083

§ 371 Date: May 23, 2016

(30) Foreign Application Priority Data
Sep. 18, 2013 (HU) P1300539

(51) Int. Cl. B01J 31/24; B01J 37/04; H01M 8/0612; C01B 3/04; H01M 8/04089; B01J 31/22; C01B 3/00

(52) U.S. Cl. CPC B01J 31/2457; B01J 31/2295; B01J 31/2273; B01J 37/04; C01B 3/0073; C01B 3/042; H01M 8/04089; H01M 8/0618; B01J 2231/70; B01J 2231/62; B01J 2531/827

(57) ABSTRACT

The invention relates to a catalyst according to the formula IrCl(cod)(NHC)]+nP (n=2, 3 or 4), or [Ir(cod)(NHC)(P)]+nP (n=1, 2 or 3), which is suitable to decompose formates in an aqueous reaction system, and for the production of hydrogen gas free of COₓ or hydrogenation of hydrogen carbonates, wherein Ir means iridium; Cl means chloro; cod means 1,5-cyclooctadiene; NHC means N-heterocyclic carbene, preferably 1-R-3-methylimidasolium chloride, wherein R means C1 to C5 alkyl and P means 1,3,5-triaza-7-phosphaadamantane (pta), monosulphonated triphenilphosphine (mtppms), trisulphonated triphenylphosphine (mtppts), or tetrasulphonated diphenylphosphynopropane (dpppts). Furthermore, the invention relates to a process for the preparation of the catalyst according to the invention. Further, the invention relates to a process for the decomposition of formate in aqueous reaction system, and for the production of hydrogen gas free of COₓ, still further, a process for the hydrogenation of hydrogen carbonate in an aqueous reaction system, as well as the production of the respective formate. Further, the invention relates to a process for the decomposition of formate according to the invention, and the hydrogenation of the hydrogen carbonate generated in the same reaction system. The invention relates to a hydrogen storage system based on the process according to the invention, preferably accumulator or fuel cell, and the use thereof.

The invention relates to a mixed complex catalyst containing iridium-carbene-phosphine, which is suitable for the decomposition of formates in an aqueous reaction system and for the production of hydrogen gas free of COₓ side products, or for the hydrogenation of hydrogen carbonates, furthermore for the performance of said reactions in a cycle. The invention furthermore relates to a process for the preparation of the catalyst according to the invention by mixing of stoichiometric amounts of the components of the catalyst in an aqueous medium. The invention furthermore relates to a process for the decomposition of formate in an aqueous medium and for the production of hydrogen gas without COₓ side products, wherein said formate is contacted with the catalyst according to the present invention or its components mixed in situ. The invention furthermore relates to a process for the hydrogenation of a hydrogen carbonate in an aqueous reaction system, and for the production of the corresponding formate, wherein said hydrogen carbonate is contacted with the catalyst according to the present invention or its components mixed in situ. Still further, the invention relates to a process for the decomposition of a formate according to the invention, and for the hydrogenation of the hydrogen carbonate produced in the same reaction system according to the present invention, wherein by using the reaction systems according to the present invention, and by flexibly selecting the reaction conditions the reactants and the reaction products are generated in a reversible reaction cycle, and the number of said reaction cycles is repeated as needed. The invention furthermore relates to a hydrogen storage system based on the process according to the present invention; preferably an accumulator or a fuel cell, Finally, the invention relates to the use of the hydrogen storage system, accumulator or fuel cell for storing of the fuel or its raw material, and optionally for the release of said fuel or its raw material as needed.

### BACKGROUND ART

The accumulation of carbon dioxide in the atmosphere results in irreversible changes in our environment. Therefore it become necessary to remove the carbon dioxide responsible for the greenhouse effect from the atmosphere, or reduce of the amount of said carbon dioxide, or the utilization of it as raw material. In the course of the reduction of carbon dioxide formic acid, formaldehyde, methanol, then methane is produced. Its use of C1 source is hindered by the fact that the compound is thermodynamically very stable and is rather inert kinetically. There is a need for the elaboration of efficient methods for its activation. The reduced form of carbon dioxide may also play important role in the storage of energy. Due to the increasing energy need of the economies, the production and storage of hydrogen became one of the important questions to be resolved in the problem of the renewable energy sources.

Generally speaking about this topic, there is extensive research all around the world, even if we focus on the homogenous catalytic systems. A number of methods is known for the storage of hydrogen both by physical, and by chemical routes. However, a final process, which may be carried out in the best and most economic manner, is still to be elaborated. The success of such researches may constitute a key question from the aspect of the energy supply of the future.

In the fundamental work of Ertl and Tornau (Z. Physik. Chem. Neue Folge, 1976, 104, 309-320) the catalytic decomposition of formaldehyde was investigated on the surface of palladium. They identified exclusively hydrogen and carbon monoxide among the reaction products at near ambient temperature, within stationary reaction conditions.

Gorin et al. (ACS Energy and Fuels Symposium, 1976) investigated the catalytic production of hydrogen in the aqueous medium of alkali formates. In their studies they found the active carbon supported MoS₂-catalyst the most effective.

U.S. Pat. No. 4,067,958 discloses a process, wherein hydrogen is produced from fuel gas containing carbon monoxide and other components. The fuel gas is lead through an aqueous solution containing sodium and potassium carbonate and/or bicarbonate, when the corresponding formate is produced. The formate solution is then catalytically decomposed, while hydrogen is developed, and carbonate and/or bicarbonate is produced. The patent document discloses also an equipment for carrying out the claimed process. The catalysts used are transition metals, their oxides or sulphides, supported by a carrier, which resists alkalines.

U.S. Pat. No. 4,372,833 discloses a process, by which hydrogen is produced from an aqueous formate solution at a relatively low temperature. The catalyst is generated as a result of near UV radiation from a metal carbonyl compound according to the general formula of M(CO)₂ by the exclusion of oxygen. In a preferred embodiment of the description the metals that may be used are chromium, molybdenum and tungsten, furthermore, the aqueous formate solution also contains some kind of solvent carrying hydroxyl group, such as, e.g. 2-ethoxy-ethanol or triethyl-glycol.

U.S. Pat. No. 4,507,185 discloses a similar solution to that of the above referred U.S. Pat. No. 4,372,833, however, more efficient catalysts are disclosed, which decompose the formate at a higher reaction rate. The disclosed catalysts may be described by the general formula according to RMn(CO)₃, wherein in the preferred embodiments R means a cyclopentadienyl group, which is unsubstituted or substituted by one methyl group.

Laurenczy et al. (Inorg. Chem. Comm. 2007, 10, 558-562) have published a Ru(II)-complex, in particular the complex according to the formula of [RuCl₂(PTA)([9]aneS₃)] (wherein PTA means 1,3,5-triaza-7-phosphoadamantane and [9]aneS₃ means 1,4,7-tritiacyclononane), which can catalyze the hydrogenation of carbon dioxide and bicarbonates in an aqueous medium. It is admitted in the publication that although the catalytic activity is rather poor, the appearance of the intermediary products generated during the reaction, which intermediary products have also been anticipated by the earlier theoretical and practical results, has been indisputably proven.

In the joint publication of Jeroro and Vohs (Catal. Lett. 2009, 130, 271-277) investigated the heterogeneous catalytic decomposition of formic acid in the presence of a Zn/Pd(111) catalyst. It was known from earlier publications that on the surface of the Pd(111) single crystal the decomposition of formic acid results in the mixture of carbon monoxide, carbon dioxide, hydrogen and water. It is disclosed in the referred publication that in the presence of small amount of zinc mounted on the surface of the Pd(111) the route leading to the generation of carbon dioxide becomes preferable for the reaction system.

Park et al. (Chem. Comm. 2011, 47, 3972-3974) published a fuel cell, in which hydrogen is released from formic acid via a biological reaction route. The carbon dioxide is removed from the generated hydrogen by alkaline washing, and the purified hydrogen is vented through a membrane electrode. The published process does not require high temperature (T≦40° C.).

WO2012160015 discloses a process for the preparation of amine compounds deuterated in the alpha- and/or beta position as compared to the N-atom. Thy catalysts used in the process are Ru(II)-complexes, which coordinate cyclopentadienyl and carbonyl groups as ligands. The referred patent document does not offer a solution for the preparation of hydrogen.

The publication of Liu and Rempel (J. Mol. Catal. 2007, 278, 228-236) discloses the reduction of aromatic aldehydes to alcohols, wherein sodium formate solution is used as hydrogen source, and Ru(II) complexes anchored to swelling polymer carriers are used as catalyst. The objective of the solution according to the publication is the production of hydrogen useful as energy source.

Fukuzumi et al. in US20120321550 (starting from the earlier works of Y. Himeda) disclose in details mononuclear transition metal complexes useful in hydrogen storage processes (including the stereoisomers, too). In their case hydrogen is developed from alcohols, then the starting alcohol is recovered from the generated aldehyde by hydrogenation using a similar catalyst. Furthermore, the HCOOH/HCOO—/CO₂/HCO₃- equilibrium has successfully been applied. The pH is also a key question in their case in a given system, also because of the pH sensitivity of the ligand. Although in the systems disclosed in the above cited patent document the formate/hydrogen carbonate cycle plays role, however, the catalyst system used is of different structure as compared to that of disclosed in the present invention, and it includes neither N-heterocyclic (in the following sometimes: NHC) carbene, nor phosphine.

In U.S. Pat. No. 6,596,423 Mahajan summarizes his experiments in the decomposition of formate catalysed by transition metal complexes (sodium, potassium, lithium and cesium). The reaction conducted according to the disclosed process (at a temperature ranging from 80 to 150° C.) results in carbon monoxide traces as well (less than 50 ppm) in the reaction product. A number of possible complexing metals, among others iridium are mentioned in said patent document. The catalysts that are worth mentioning may be transition metal-carbonyl complexes and complexes coordinating a ligand including an N donor group (e.g. a 2,2′-dipiridyl group). For the medium of the reaction a number of opportunities are given, e.g. water or methanol.

In DE102006030449 an equipment is disclosed that is suitable for the reversible storage of hydrogen. The operation of the equipment is based on the catch and release of hydrogen. The hydrogen is caught in such a manner that potassium carbonate and/or potassium hydrogen carbonate is reduced to potassium formate in an aqueous solution, using electricity in the presence of hydrogen gas and a ZnO or ZnO\TiO₂ catalyst.

The release of hydrogen from the aqueous solution of potassium formate, formic acid or their mixture is effected with the help of platinum or palladium catalysts. It is to be noted that not the same catalyst is used for the storage of hydrogen and the release of hydrogen.

In U. S. Pat. No. 7,939,461 metal complexes are disclosed, which catalyse the decomposition of formic acid accompanied by hydrogen formation. In the application the theoretical opportunity of an equipment is also disclosed, which makes it possible the storage and recycling of the hydrogen generated during the decomposition of formic acid. The disclosed metal complexes include two transition metal atoms (binuclear complexes), which may be identical or different from each other. Among the metal atoms mentioned in the patent description there is iridium. The possible ligands in the substituted or unsubstituted form are selected from the group of cyclopentadiene, heterocyclic aromatic compounds comprising N-atom, such as bipyridine, phenantroline, bipyrimidine. In the examples disclosed the preparation of a water soluble iridium-rhutenium-complex, and the decomposition of formic acid accompanied by the generation of hydrogen and carbon dioxide in different reaction conditions (varying pH and temperature) are demonstrated. Complexes (e.g. containing iridium) are also disclosed in the description, which catalyse the formation of formic acid from hydrogen and carbon dioxide. The catalysts disclosed in the referred patent document are of different structure as compared to those catalysts disclosed in the present specification (e.g. do not comprise phosphine ligands).

Beller et al. investigated the decomposition of formic acid also in homogenous catalytic reactions using Ru-catalysts (Angew. Chem. Int. 2008, 47, 3962-3965). It has been demonstrated that it is possible to prepare hydrogen at low temperatures, catalytically from different formic acid-amine adducts. In the reaction products only hydrogen and carbon dioxide could be detected. In the experiments the most effective precursor was the commercially available [RuCl₂(PPh₃)₃] complex

Beller and his research group disclosed in their another publication (Tetrahedron Lett. 2009, 50, 1603-1606), how the hydrogen preparation from formic acid with Ru-containing catalyst can be influenced by the addition of organic bases and inorganic salts to the catalyst system. It has been demonstrated that the presence of amidine compounds increases the hydrogen yield, furthermore, within optimal reaction conditions hydrogen can efficiently be developed from a formic acid/amine mixture. The catalyst system has proven to be the most effective in case of [RuCl₂(benzene)]₂ precursor in the presence of 1,2-bis-(diphenyl-phosphine)-ethane (dppe) and N,N-dimethyl-n-hexyl-amine.

In another publication of Beller et al. (ChemSusChem 2008, 1, 751-758), they investigated also the possibility of the preparation of hydrogen from formic acid/amin-adducts at room temperature. The best catalytic activity achieved was the TOF=3630 h⁻¹ value. As catalyst different Ru-containing precursors and phosphine ligands were used.

Beller et al. in a summarizing publication (Top Catal. 2010, 53, 902-914) review the opportunities of using formic acid and its derivatives for the storage of hydrogen, furthermore, the homogenous catalytic production of hydrogen from aqueous solutions of formic acid/metalformate.

Furthermore, Beller et al. performed investigations for the discovery of the effects of illumination (Chem. Commun. 2009, 4185-4187), and demonstrated that in a number of cases the illumination has a positive rate increasing effect that is in certain cases the activity of the catalyst could be increased by applying illumination. The most effective catalyst system contained the above-mentioned [RuCl₂(benzene)]₂ precursor and 1,2-bis-(diphenil-phosphine)-ethane (dppe) as ligand.

Summarizing the published results of Beller et al. referred to above, it can be stated that in their systems the catalyst-precursor is represented by the Ru-arene type complexes that can be dissolved in organic solvents. Furthermore, besides formic acid, a number of different organic amines have been used to catch the CO₂ generated. They suggest that in the complete cycle the hydrogenation of the CO₂-amine-adduct is easier to convert them to free acid and amine, than the hydrogenation of the carbon dioxide. However, they made no specific attempt for carrying this out, in their publications they primarily dealt with the optimization of the conditions of the decomposition through the exchange of the catalyst-precursor and the applied ligands, furthermore, they investigated the effect of different amines on the decomposition.

WO2012143372 discloses a process, wherein hydrogen can be generated from formic acid by selective hydration, using a catalyst system comprising transition metal complexes coordinating at least one tetra-dental ligand. Although among the transition metals that may be used iridium is mentioned, in the preferred embodiment of the invention ruthenium, cobalt and iron is disclosed. In the description phosphine ligands are mentioned, however, the carbene-complexes of transition metals are not mentioned as precursor.

Beller et al. in another publication (Angew. Chem. Int. Ed. 2011, 50, 6411-6414) prove the suitability of the formate/hydrogen carbonate cycle for the storage of hydrogen. The tested active catalyst is a Ru(II)-bisphosphine, which cannot be dissolved in water, therefore water-DMF mixture was used as reaction medium, and the forth-and-back reaction within one system could not be carried out in one system (the solution had to be separated after the decomposition, and the hydrogenation had to be carried out in another reaction vessel).

Jóó Ferenc et al. [Angew. Chem. Int. Ed. 2011, 50, 10433-10435 (in the following: own research results)] investigated also the possibilities of application of the formate/hydrogen carbonate cycle. The catalyst disclosed here is a Ru(II)-mtppms-complex, from which Ru-formate-dihydride is generated during the reaction, which then causes the decomposition. The chemical storage of H₂ in formate could be achieved in one system, as at the applied temperature the formate decomposes in the presence of the Ru(ü)-mtppms catalyst (no CO₂ evolving), while finishing the decomposition, by charging of the solution of the generated HCO₃- and catalyst with a relatively high pressure of H₂, the starting formate solution can be recovered. The cycle could be performed several times repeatedly.
In the systems according to the two publications mentioned immediately above, though the formate/hydrogen carbonate cycle plays role, however, the catalyst is a Ru(II)-complex, and the complexes of iridium or other transition metals are not even mentioned, furthermore, neither the application of NHC-carbene as ligandum is mentioned.

Himeda (Green Chem. 2009, 11, 2018-2022) investigated the decomposition of formic acid in an aqueous medium, in the presence of iridium-catalyst. The hydrogen generated did not contain carbon monoxide. As ligand 4,4′-dihydroxy-2,2′-bipyridine was present. Based on the results, the Ir-bipyridyl-complexes have proven to be very active catalyst. At 90° C. the catalytic activity reached the value of TOF=14000 h⁻¹. The author also investigated the effect of formate on the decomposition of formic acid. It has been stated that this catalyst is active in the decomposition of HCOOH/HCOO— mixtures. Furthermore, it has been anticipated on the principal-theoretical level that the aqueous solution of the produced CO₂ (HCO₃- solution) may be hydrogenated back, and by reducing the pH again formic acid is generated. There was a suggested mechanism for the reaction, in which the catalytically active intermediate was identified as Ir-H.

Using a similar Ir-catalyst, also Himeda et al. achieved the hydrogenation of the CO₂ generated from the decomposition of formic acid by the amendment of the pH within one system (Nature Chem. 2012, 4, 383-388). Their applied catalyst (through the pH-sensitivity of the ligand) catalyzes the decomposition of formic acid in the acidic pH range, while in alkaline solutions the reduction of CO₂ becomes preferred. It was suggested that H₂ can reversibly be stored in formate solutions.

Although the formate/hydrogen carbonate cycle also appear in the immediately above-mentioned two publications, however, the applied catalyst comprises neither NHC-carbene, nor phosphine, the pH is in the acidic range during the decomposition, that is the formic acid decomposes (CO₂ is also generated), and the pH should always be elevated, in order to have the reduction process also started, unlike our system according to the present invention, wherein the pH does not substantially changes.

Nolan et al. in U.S. Pat. No. 6,774,274 disclose complexes according to the general formula of [Ir(cod)(N)(L)]X, which are prepared by the reaction of [Ir(cod)(py)₂)]PF₆ (wherein cod means 1,5-cyclodihydroxy, py means pyridine) and L or NL ligands. They furthermore disclose the application of said catalysts in the hydrogenation of olephines. The method for the preparation and the characterization of the main features of the complex according to the general formula of [Ir(cod)(py)(SIMes)]PF6 (wherein SIMes means 1,3-dimesityl-4,5-dihydro-imidasole-2-ylidene or the relating N-heterocyclic carbene) is also presented. In the cited patent the nucleophile-type N-heterocyclic carbenes are mentioned as the alternatives of the phosphine ligands widespread in the homogenous catalysis, emphasizing the general experimental finding that using of N-heterocyclic carbene ligands of more preferred sterical characteristics in place of phosphine ligands, a significant increase in the catalytic performance can be achieved in case of olephines. The patent document does not disclose catalysts containing the mixture of NHC-carbene- and phosphine ligands, at the same time, it offers a solution of a principally different technical problem.

In his summarizing publication Joó, Ferenc (ChemSusChem 2008, 1, 805-808) reviews the works and the promising results thereof of two research groups: Beller at al., and Laurenczy et al., in the fields of the hydrogen storage systems. In said publication the author emphasizes the importance of the presented results from the point of view of the energy storage and transport.

Laurenczy et al. disclose (Angew. Chem. Int. Ed. 2008, 47, 3966-3968) an efficient, selective system, which is suitable for the generation of hydrogen from the aqueous solution of formic acid, in the presence of a water soluble, in situ produced catalyst. As a precursor a [Ru(II)(H₂O)₆](tos)₂]-complex, wherein tos means toluil-4-sulphonate, or RuCl₃ was used, as ligand meta-trisulphonated triphenylphosphine (TPPTS) was used. Sodium formate was added to the solution in order to activate the catalyst.

Laurenczy et al. in another publication (Chem. Eur. J. 2009, 15, 3752-3760) present the results of the further investigation of the above-mentioned system. As precursor, besides the already mentioned compounds the [Ru(III)(H₂O)₆](tos)₃] complex was also investigated. The effect of the reaction conditions on the rate of decomposition was analysed, and it the optimal reaction conditions were determined. Modem analytical techniques were used to determine the structure of the catalytically active intermediary products, and the mechanism of the reaction was anticipated on the basis of theoretical calculations.

Laurenczy et al. in their further publication (ChemCatChem 2013) studied the catalytic decomposition of the HCOOH/HCOO— mixture in the presence of a Ru ion containing, water soluble catalyst, wherein the ligands constituting the complex were cationic triarylphosphine derivatives substituted by one or more trimethylammonium group. Optimization tests were also made with the most promising precursor, during which, among others, the effects of the pH, the temperature, the concentration of the catalyst, and the proportion of the ligand/Ru were investigated. The TOF value within optimal reaction conditions reached the value of TOF=1950 h⁻¹.

In the above-mentioned publications the catalyst system is based on ruthenium, and it contains a variety of phosphine ligands though, however, no mention is made about the NHC-carbenes as possible ligands.

The patent application WO2008047312 of Laurenczy el al. relates to a process, with which hydrogen and carbon dioxide can be prepared in an aqueous medium from formic acid by a catalytic route, without the generation of carbon monoxide. The catalysed process can be carried out at a wide range of temperatures, including room temperature (T=25° C.) as well. The most important aspects of the above-mentioned patent document from the point of view of the problem according to the present invention are as follows:
besides formic acid the formate salts are also mentioned as compounds, which are suitable for the storage of hydrogen in themselves, but experimental results are not presented for the illustration that the catalyst systems applied by them would be active in the decomposition of the aqueous solutions comprising only formate salts;
the patent document mentions iridium as transition metal, the complexes of which can be suitable as catalyst in the studied processes, however, no experimental results are demonstrated in this respect. Iridium is not mentioned as a preferred embodiment of the invention.
the patent document mentions phosphines, preferably aromatic phosphines, in particular mtppts and mtppms ligands, and carbenes among the possible ligands of the transition complex catalysts. Specific examples for the carbene are not mentioned.
it is substantial difference, furthermore, that the other step of the hydrogen storage, namely when the carbon dioxide, or as in our case the HCO₃- solution generated during the decomposition is converted back to formic acid, or formate solution, respectively, is not mentioned in the cited patent document.

Laurenczy et al. in U.S. Pat. No. 8,133,464 disclose also the decomposition of a variety of formic acid/formate mixtures to hydrogen and carbon dioxide. The circle of the catalysts applied has been extended as compared with their earlier (WO2008047312). The patent document discloses complex according to the general formula of M(L)ₙ, wherein M is preferably Ru and Rh, but it may be Ir as well. For L as a ligand a number of alternatives are claimed, wherein L may be sulphonated phosphine and/or carbene and/or hydrophilic group and a combination thereof. However, the carbenes that may be applied as ligands are not specified in this patent document, either.

In the present invention the active catalyst is in situ generated from the compound according to the general formula of [Ir(NHC-carbene)XY]+2P, or [Ir(NHC-carbene)XP]+P, wherein X means hydrophobic group, preferably cyclooctadiene, Y means a hydrophilic group, preferably Cl-ion, P means a sulphonated phosphine, preferably mtppts and/or mtppms, or sulphonated bis-phosphines (pl. dpppts). The catalyst generated in situ plays role only in the decomposition of aqueous solutions comprising formates (that is not formic acid), while according to the cited patent document the catalyst is used in the decomposition of HCOOH/HCOO— mixtures (experimental results are not disclosed in this respect). The referred patent documents also mention that among the catalytical conditions used both the pure HCOOH and HCOO— decomposes only at a very low reaction rate. Furthermore, the pH of the aqueous solution according to the present invention is 8.3±0.2, which falls outside the 0 to 8 range disclosed in the cited patent document.

It is a further substantial difference is that in U.S. Pat. No. 8,133,464 does not either discloses the other step of the hydrogen storage, wherein the CO₂ generated during the decomposition, or in our case the HCO₃- solution is converted back to formic acid, or formate-solution, respectively.

The fundamental problem according to the present invention is that a reaction system is needed to be found, which can be used in fuel cells, is suitable for reversible hydrogen storage, which makes it possible the production of hydrogen gas (H₂) free of COₓ side products by the decomposition of formates in an aqueous reaction system, furthermore, the hydrogenation of the hydrogen-carbonates produced in the same reaction system using the same catalyst.

As a result of our work it has been surprisingly found that the catalyst with specific composition disclosed in our invention can catalyze the decomposition of formates, and the hydrogenation of the hydrogen-carbonates, respectively, by selecting the appropriate conditions. Said flexibly adjustable reaction system comprising said catalyst of specific composition constitutes the base of the hydrogen storage system according to the objective of the present invention.

### BRIEF DESCRIPTION OF THE DRAWINGS

FIG. 1: Catalytic cycle useful for the storage of hydrogen.

FIG. 2: Arrangement of the gas burette.

FIG. 3: The change of the values of the number of catalytic cycles (TurnOver Frequency, in the following sometimes: TOF) in the decomposition of HCOONa using [IrCl(bmim)(cod)]+pta catalyst.

FIG. 4: The change of the TOF values in the decomposition of HCOONa using [IrCl(bmim)(cod)]+dpppts catalyst.

FIG. 5: The change of the TOF values in the decomposition of HCOONa using [IrCl(bmim)(cod)]+mtppts catalyst.

FIG. 6: The change of the TOF values in the decomposition of HCOONa using [IrCl(bmim)(cod)]+mtppms catalyst.

FIG. 7: The use of [IrCl(bmim)(cod)]+mtppts catalyst in the HCOO—/HCO₃- cycle as compared with the Ru-system.

### DETAILED DESCRIPTION OF THE INVENTION

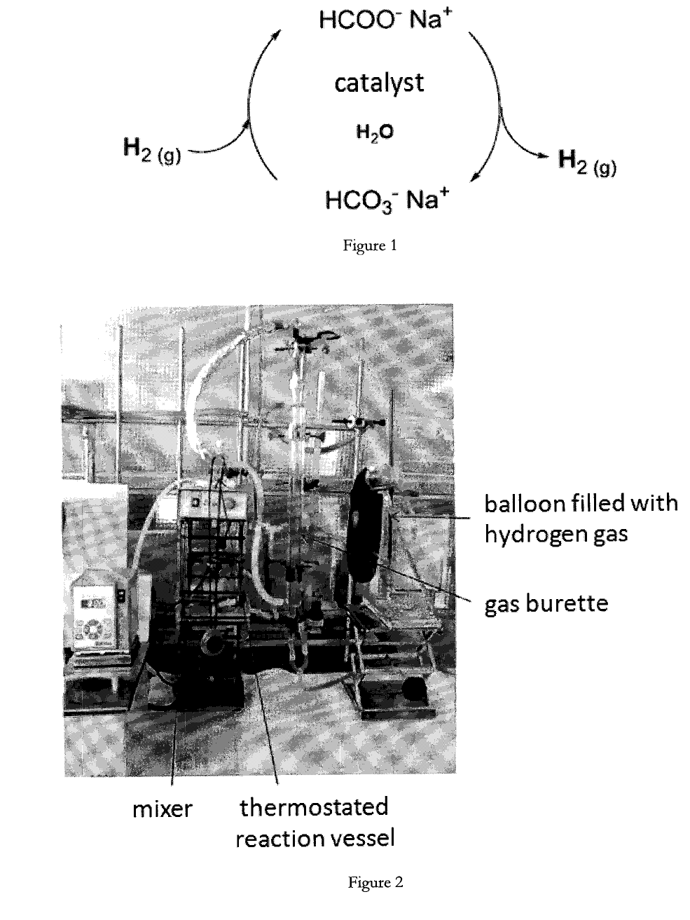

As result of our work we have prepared compounds with the general formula of [IrCl(cod)(NHC)(P)]+P (wherein cod means 1,5-cyclooctadiene; NHC means N-heterocyclic carbene and P means water soluble phosphine), which effectively catalyze the decomposition of different formates, first of all sodium formate (HCOONa) in aqueous medium, and the hydrogenation of the hydrogen carbonate (HCO₃-) generated from said sodium formate in the same system. The general scheme of the reaction is illustrated by FIG. 1.

The method is based on the hydrogenation of hydrogen carbonate (HCO₃-) to formate (HCOO—), then the decomposition of the formate (HCOO—) to hydrogen carbonate (HCO₃-) in an aqueous medium, in the presence of water soluble catalysts.

Based on the above, according to the first aspect of the present invention a catalyst according to the general formula of [IrCl(cod)(NHC)]+nP is provided, which is useful for the decomposition of formates in an aqueous reaction system and for the production of hydrogen gas (H₂) which is free of COₓ side products, or for the hydrogenation of hydrogen carbonates (HCO₃-), wherein in the formula Ir means iridium, Cl means chloro, cod means 1,5-cyclooctadiene and NHC means an N-heterocyclic carbene, preferably 1-R-3-methylimidazolium chloride, wherein R means C1 to C5 alkyl group, preferably C2 or C4 alkyl group, P means 1,3,5-triaza-7-phosphaadamantane (pta), monosulphonated triphenylphosphine (mtppms), trisulphonated triphenylphosphine (mtppts), or tetrasulphonated diphenylphosphinopropane (dpppts), furthermore, n means an integer with the value of 2 to 4.

Preferably in the catalyst n has the value of 2 to 3, more preferably 3, and P means pta.

Preferably in the catalyst n has the value of 2 to 3, more preferably 2, and P means dpppts.

Preferably in the catalyst n has the value of 2 to 4, more preferably 2 to 3, most preferably 2 and P means mtppts.

Preferably in the catalyst n has the value of 2 to 4, more preferably 2 to 3, most preferably 2 and P means mtppms.

Another aspect of the present invention is a catalyst with the general formula according to [Ir(cod)(NHC)(P)]+nP, which is useful for the decomposition of formates in an aqueous reaction system and for the production of hydrogen gas (H₂) or for the hydrogenation of hydrogen-carbonates (HCO₃-), wherein in the formula Ir, cod, NHC and P has the same meaning as above, furthermore, n means an integer with the value of 1 to 3.

As catalyst a complex according to the general formula [IrCl(cod)(NHC)] (wherein NHC means N-heterocyclic carbene; bmimCl means 1-butyl-3-methylimidazolium chloride and emimCl means 1-ethyl-3-methylimidazolium chloride) and a number of water soluble phosphines were used. The [IrCl(cod)(NHC)] precursor was obtained from IrCl₃ as a starting material, in a multi-step reaction, while the final catalysts, containing water soluble phosphine were prepared in each case within inert conditions, in situ:
1. [IrCl(cod)(NHC)]+nP, wherein n means an integer of 2 to 4, P means pta; mtppms; mtppts, dpppts, NHC means 1-R-3-methylimidazolyum chloride, wherein R means C1 to C5 alkyl group (pta means 1,3,5-triaza-7-phosphaadamantane, mtppms means monosulphonated triphenylphosphine, mtppts means trisulphonated triphenylphosphine and dpppts means tetrasulphonated diphenylphosphinopropane);
2. [Ir(cod)(NHC)(P)] nP, wherein n means an integer of 1 to 3, P means pta, mtppms, mtppts, dpppts and NHC means 1-R-3-methylimidazolium chloride, wherein R means C1 to C5 alkyl group.

Thus, a further aspect of the present invention is that a process is provided for the preparation of the catalyst according to the present invention, wherein the stoichiometric amounts of the components of the catalyst are mixed with each other in an aqueous medium.

For carrying out the catalytic cycle primarily sodium formate is used as substrate, however, investigations were made with other inorganic formates (HCOOLi, HCOOCs, HCOOK) as well. The majority of the test reactions were measured in gas burette (FIG. 2).

Gas volumetry is an analytical method, which is based on the measuring of the volume of gases. It can be used in every case, when as is evolved or absorbed. The amount of the gas developed at a given temperature can be read from the gas burette.

A further aspect of the present invention is that a process is provided for the decomposition of a formate, preferably sodium formate (HCOONa), lithium formate (HCOOLi), cesium formate (HCOOCs) or potassium formate (HCOOK) in an aqueous reaction system, and for the production of hydrogen gas (H₂) without COₓ side products, wherein said formate and a catalyst according to the present invention or the in situ mixed components thereof are contacted with each other, at an elevated temperature, preferably at 60 to 100° C., preferably at 80° C., preferably at a pH>8, preferably at pH=8.3±0.2, in Ar gas atmosphere.

In another aspect of the present invention a process is provided for the hydrogenation of a hydrogen carbonate (HCO₃-), preferably sodium hydrogen carbonate (NaHCO₃), lithium hydrogen carbonate (LiHCO₃), cesium hydrogen carbonate (CsHCO₃) or potassium hydrogen carbonate (KHCO₃) in an aqueous reaction system and for the preparation of a formate, preferably for the preparation of sodium formate (HCOONa), lithium formate (HCOOLi), cesium formate (HCOOCs) or potassium formate (HCOOK), wherein said hydrogen carbonate and a catalyst according to the present invention or the in situ mixed components thereof are contacted with each other, at an elevated temperature, preferably at 60-100° C., more preferably at 80° C., under a pressure of 1-1200 bar, preferably 10-100 bar.

It is another aspect of the present invention that a process is provided for the decomposition of a formate, preferably sodium formate (HCOONa), lithium formate (HCOOLi), cesium formate (HCOOCs) or potassium formate (HCOOK) in an aqueous reaction system, and for the production of hydrogen gas (H₂) free of COₓ side products, and for the hydrogenation of the hydrogen carbonate (HCO₃-), preferably sodium hydrogen carbonate (NaHCO₃), lithium hydrogen carbonate (LiHCO₃), cesium hydrogen carbonate (CsHCO₃) or potassium hydrogen carbonate (KHCO₃) generated in the same reaction system in an aqueous reaction, thus for the preparation of a formate, preferably sodium formate (HCOONa), lithium formate (HCOOLi), cesium formate (HCOOCs) or potassium formate (HCOOK), wherein by the flexible selection of the reaction conditions and using the reaction system of the process according to the present invention for the decomposition of a formate, and the process according to the present invention for the hydrogenation of hydrogen carbonate, the reactants and the reaction products are prepared in a reversible reaction cycle, and this reaction cycle is repeated as needed.

As a water-soluble phosphine ligandum mono-(mtppms), and trisulphonated (mtppts) triphenyl-phosphine, tetrasulphonated diphenylphosphinopropane (dpppts) and phosphatriaza-adamantane can be applied.

Furthermore, the present invention relates to a hydrogen storage system, which comprises the components according to the invention as disclosed above. Preferably hydrogen storage system according to the present invention is an accumulator or a fuel cell.

Finally, the present invention relates to the use of the system or cell according to the invention for the storage of a fuel or the raw material thereof, and optionally for the release of said fuel or the raw material thereof as needed.

In the following the present invention is illustrated by examples, which, however, are not in any way to be construed as a limitation of the invention.

The decomposition of HCOONa was investigated in an atmospheric thermostated gas burette in an aqueous medium, with inert atmosphere with in situ generated [IrCl(cod)(NHC)P]+P catalysts (wherein NHC means N-heterocyclic carbene, preferably bmim; P means water soluble phosphine ligand, selected preferably from the group of mtppms, mtppts, dpppts or pta ligands). The amount of the developed hydrogen gas was continuously monitored in time, and from the rise of the line fitted to the starting part of the gas evolution curves catalytic TOF was calculated, which characterizes the activity of a given system.

A typical reaction mixture in a 50.0 mL thermostated atmospheric gas burette:
5.5 mL volume of the solution,
80° C., Ar-atmosphere,
[Ir]=0.002 mol/dm³,
[phosphine]=(1-4)×[Ir], and
[HCOONa]=0.240 mol/dm³.

It has been demonstrated that the [IrCl(bmim)(cod)] complex used as the catalyst precursor only poorly dissolves in water, and does not show activity in the decomposition of the formate, either. No increase in the solubility or increase in the activity was experienced on addition of further carbene-precursor in the above-mentioned process. It has been demonstrated that the application of water soluble phosphines in the present catalytic systems is preconditional.

### EXAMPLE 1

### The Application of 1,3,5-Triaza-7-Phosphaadamantane Ligand

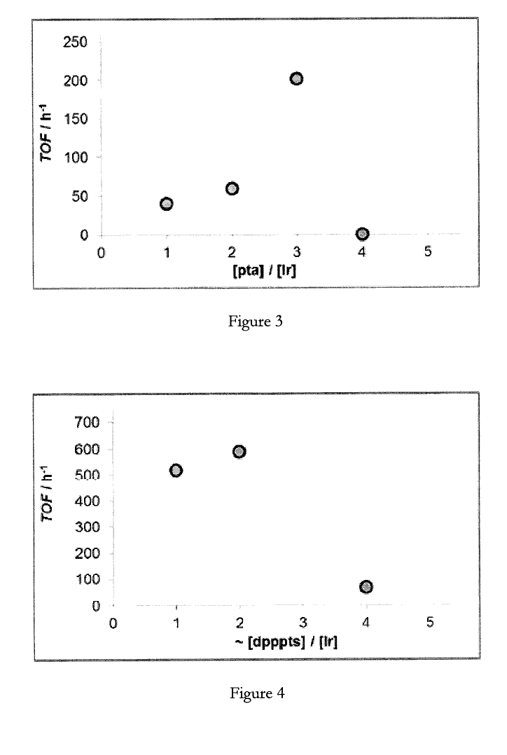

Using 1,3,5-triaza-7-phosphaadamantane (pta) as phosphine in a variety of amounts the points according to FIG. 3 were obtained. It has been shown that the maximum catalytic activity was experienced in case of pta/Ir=3 proportion, on addition of further phosphine ligand the decomposition practically stops, the catalyst is deactivated.

Based on the above experimental results, a preferred embodiment of the present invention is the catalyst according to the general formula of [IrCl(cod)(NHC)]+nP, wherein Cl, cod and NHC has the same meaning as above, furthermore n has the value of 2 or 3, preferably 3, and P means pta.

### EXAMPLE 2

### The Application of Tetrasulphonated Diphenylphosphinopropane Ligand

Using a water soluble diphosphine ligand (tetrasulphonated diphenylphosphinopropane, dpppts) in the catalytic system the TOF values according to FIG. 4 have been obtained. In this case the maximum activity was obtained in case of dpppts/Ir=2 proportion, and the addition of further phosphine deactivated the catalyst.

Based on the above experimental results shown in FIG. 4, a further preferred embodiment of the present invention is the catalyst according to the general formula of [IrCl(cod)(NHC)]+nP, wherein Cl, cod and NHC has the same meaning as above, furthermore n has the value of 2 or 3, preferably 2, and P means dpppts.

### EXAMPLE 3

### The Application of Trisulphonated Triphenylphosphine Ligand

Using the trisulphonated triphenylphosphine (mtppts) the TOF according to FIG. 5 was achieved. The results show that at a mtppts/Ir=2 proportion the maximum activity values is achieved, and the excess mtppts does not significantly decreases the initial rate of the decomposition.

Based on the above experimental results, a further preferred embodiment of the present invention is the catalyst according to the general formula of [IrCl(cod)(NHC)]+nP, wherein Cl, cod and NHC has the same meaning as above, furthermore n has the value of 2, 3 or 4, preferably 2 or 3, most preferably 2, and P means mtppts.

### EXAMPLE 4

### The Application of Monosulphonated Triphenylphosphine Ligand

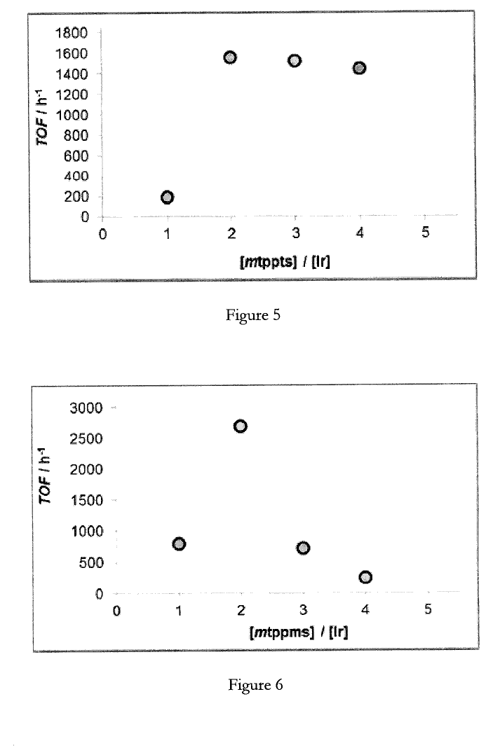

The most active ligand was the monosulphonated triphenylphosphine (mtppms) in the decomposition of the aqueous HCOONa, as it is illustrated by FIG. 6. In hydrogen production mtppms/Ir=2 proportion was found the most active and in this case the deactivation effect of the excess ligand can also be experienced.

Thus, a preferred embodiment of the present invention is the catalyst according to the general formula of [IrCl(cod)(NHC)]+nP, wherein Cl, cod and NHC has the same meaning as above, furthermore n has the value of 2, 3 or 4, preferably 2 or 3, most preferably 2, and P means mtppms.

Comparing these results with our earlier research results, it has been demonstrated that the most active Ir-containing system (containing mtppms) decomposes the HCOONa with a five times higher rate in aqueous medium within similar reaction conditions.

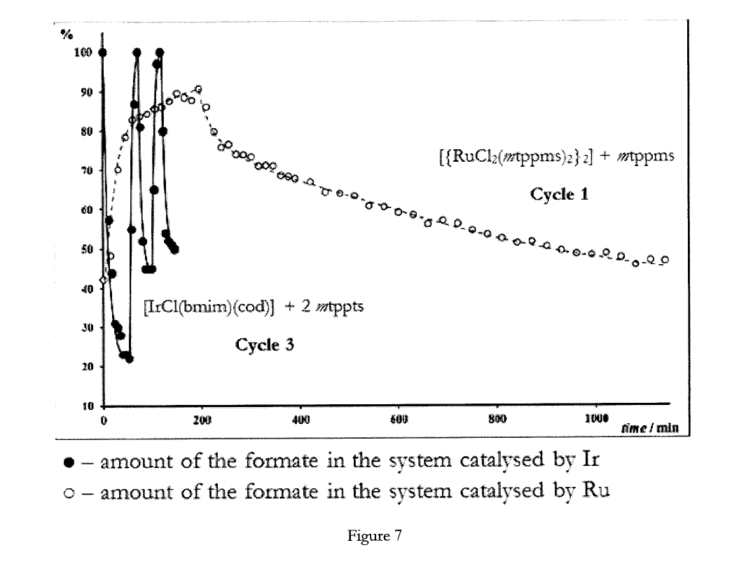

FIG. 7 shows the activity of the in situ generated catalyst according to the formula of [IrCl(bmim)(cod)]+2 mtppts in the complete cycle of the hydrogen storage (compared with the earlier research results).

Within the applied conditions comparing the functioning of the Ir-catalyst with the earlier results it has been demonstrated that both its activity and its efficiency surpasses those of the Ru-catalyst in the given hydrogen storage cycle.

A big advantage of the system according to the present invention that in case of the decomposition of formate according to the above described manner pure hydrogen can be obtained without carbon monoxide, and carbon dioxide. The produced hydrogen in turn may be used for energy production in fuel cells.

According to the present state of the present development it has been demonstrated that the catalyst of the present invention according to the general formula of [IrCl(cod)(NHC)]+nP (wherein NHC means N-heterocyclic carbene, P means water soluble phosphine ligand and n means an integer with the value of 2 to 4) surpasses the only one known and published catalyst (Ru-mtppms catalyst according to our earlier research results) which had been proven to be active without the addition of additives (base, acid, organic additives, solvents, etc.) in a system operating by the amendment of exclusively the hydrogen pressure, in the formate/hydrogen carbonate aqueous hydrogen storage cycle both in its activity and in its efficiency.

Accordingly, it is another aspect of the present invention that a hydrogen storage system is provided comprising the components according to the invention, which has a preferred embodiment, which is an accumulator or a fuel cell, furthermore, its use is provided for the storage of a fuel or the raw material thereof, and optionally for the release of said fuel or the raw material thereof, as needed.

### INDUSTRIAL APPLICABILITY

The complex catalyst according to the present invention according to the general formula of IrCl(cod)(NHC)]+nP (wherein the formula has the meanings as described above) offers the opportunity to provide for an alternative, environmentally friendly and renewable energy source, catalyzing with appropriate efficiency and activity in a single aqueous system the cyclic process for the storage and production of hydrogen, without the addition of additives and the production of COₓ side products.

1. A catalyst according to the general formula of [IrCl(cod)(NHC)]+nP, which is suitable for the decomposition of formates in an aqueous reaction system and for the generation of hydrogen gas (H₂), which is free of COₓ side products, or for the hydrogenation of hydrogen carbonates (HCO₃), wherein in the formula
Ir means iridium;
Cl means chloro;
cod means 1,5-cyclooctadiene;
NHC means an N-heterocyclic carbene, preferably 1-R-3-methylimidazolium chloride, wherein R means C1 to C5 alkyl group, preferably C2 or C4 alkyl group;
n means an integer with the value of 2 to 4; and
P means a 1,3,5-triaza-7-phosphaadamantane (pta), monosulphonated triphenylphosphine (mtppms), trisulphonated triphenylphosphine (mtppts), or tetrasulphonated diphenylphosphinopropane (dpppts).

2. The catalyst as claimed in claim 1, wherein n has the value of 2 to 3, preferably 3, and P means pta.

3. The catalyst as claimed in claim 1, wherein n has the value of 2 to 3, preferably 2, and P means dpppts.

4. The catalyst as claimed in claim 1, wherein n has the value of 2 to 4, preferably 2 to 3, most preferably 2 and P means mtppts.

5. The catalyst as claimed in claim 1, wherein n has the value of 2 to 4, preferably 2 to 3, most preferably 2 and P means mtppms.

6. A catalyst according to the general formula of [Ir(cod)(NHC)(P)]+nP, which is suitable for the decomposition of formates in an aqueous reaction system and for the generation of hydrogen gas (H₂), or for the hydrogenation of hydrogen carbonates (HCO₃-), wherein in the formula Ir, Cl, cod, NHC and P has the meaning as claimed in claim 1 and n is an integer with the value of 1 to 3.

7. A process for the preparation of the catalyst as claimed in claim 1 characterized in that the stoichiometric amounts of the components of the catalyst are contacted with each other in an aqueous medium.

8. A process for the decomposition of a formate, preferably selected from the group of sodium formate (HCOONa), lithium formate (HCOOLi), cesium formate (HCOOCs) and potassium formate (HCOOK) in an aqueous reaction system, and for the production of hydrogen gas (H₂) without COₓ side products, characterized in that said formate and the catalyst as claimed in claim 1 or the in situ mixed components thereof are contacted with each other, preferably at 60-100° C., preferably at 80° C., preferably at pH>8, preferably at pH=8.3±0.2, in an Ar-gas atmosphere.

9. A process for the hydrogenation of a hydrogen carbonate (HCO₃-), preferably selected from the group of sodium hydrogen carbonate (NaHCO₃), lithium hydrogen carbonate (LiHCO₃), cesium hydrogen carbonate (CsHCO₃) and potassium hydrogen carbonate (KHCO₃) in an aqueous reaction system and for the production of a formate, preferably selected from the group of sodium formate (HCOONa), lithium formate (HCOOLi), cesium formate (HCOOCs) and potassium formate (HCOOK), characterized in that said hydrogen carbonate and the catalyst as claimed in claim 1 or the in situ mixed components thereof are contacted with each other, at an elevated temperature, preferably at 60-100° C., more preferably at 80° C., at a pressure of 1-1200 bar, preferably 10-100 bar.

10. A process for the decomposition of a formate, preferably selected from the group of sodium formate (HCOONa), lithium formate (HCOOLi), cesium formate (HCOOCs) and potassium formate (HCOOK) in an aqueous reaction system and for the production of hydrogen gas (H₂) without COₓ side products, and in the same system the hydrogenation of the produced hydrogen carbonate (HCO₃-), preferably selected from the group of sodium hydrogen carbonate (NaHCO₃), lithium hydrogen carbonate (LiHCO₃), cesium hydrogen carbonate (CsHCO₃) and potassium hydrogen carbonate (KHCO₃) in an aqueous reaction system, thus for the production of a formate, preferably selected from the group of sodium formate (HCOONa), lithium formate (HCOOLi), cesium formate (HCOOCs) and potassium formate (HCOOK), characterized in that using of the reaction system according to claim 8 and by the flexible selection of the reaction conditions the reactants and the reaction products are generated in a reversible reaction cycle, and this reaction cycle is repeated as needed.

11. A hydrogen storage system, which comprises the components according to claim 10.

12. The hydrogen storage system as claimed in claim 11, which is an accumulator or a fuel cell.

13. Use of the system or fuel cell as claimed in claim 11 for the storage of fuel or the raw material thereof, and optionally for the release thereof as needed.
